(19) United States
(12) Patent Application Publication
(10) Pub. No.: US 2005/0108368 A1
(43) Pub. Date: May 19, 2005

(54) Method and apparatus for representing data available in a peer-to-peer network using bloom-filters

(76) Inventors: Aditya Mohan, Menlo Park, CA (US); Vasiliki Kalogeraki, Riverside, CA (US); Aad van Moorsel, Sunnyvale, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/699,359

(22) Filed: Oct. 30, 2003

(51) Int. Cl. G06F 15/177

(52) U.S. Cl. 709/220

(57) ABSTRACT

A method and apparatus is disclosed for representing data available in a peer-to-peer network of processing nodes. In one arrangement, respective Bloom-Filters may be formed at the nodes as a function of data available via the nodes. The Bloom-filters may be communicated between peer-to-peer coupled nodes of the peer-to-peer network that have formed connections using incentive-based criteria to control whether one node connects to another node. A search expression may be formed for locating a data object, and nodes selected as a function of the Bloom-filters and the incentive-based criteria. The search expression may be propagated to the selected nodes, and the result of the search expression output from nodes that satisfy the search expression.

### FIELD OF THE INVENTION

The present disclosure relates in general to communicating over data networks, and in particular to communicating queries in peer-to-peer networks.

### BACKGROUND

Over the past decades, the Internet has evolved from a special purpose collection of military and academic networks to a vital carrier of communications for many people around the world. The widespread use of email clients and web browsers has helped fuel the Internet's use by the general populace. Newer applications such as file sharing and instant messaging have further increased the traffic on the Internet.

One popular Internet application is decentralized peer-to-peer file sharing. Peer-to-peer protocols such as Gnutella allow data transfers between client computers without the use of well-known servers to categorize, direct, or otherwise manage data traffic. Gnutella is a well known peer-to-peer protocol for distributed search and data retrieval. Each host on the peer-to-peer network can serve and request data, therefore the hosts are sometimes referred to as “servents.” After finding the Internet Protocol address of at least one other servent, a host can join the peer-to-peer network.

Servents maintain one or more connections with other servents on the peer-to-peer network and perform data transfer functions of the network. These data transfer functions may include serving data, routing queries, and responding to queries. One application of peer-to-peer file sharing is to discover downloadable data that a user desires. This data is often in the form of a file, and can be located by the file's name or other meta-data embedded in the file.

When a user wishes to find a particular file or other data on the network, the user will form a query. This query may include an identifier of the desired data object, and the query may include terms that may be found in the meta-data, such as a title or name of the originator. The query is then broadcast to each immediately connected servent, each of which checks a local repository. If these servents do not have the data, the query is forwarded along the network where the process is repeated until matches are found.

Although this method of querying is effective, it can be inefficient. For example, assuming an average query contains 83 bytes of data and is sent over a network. The network is assumed to have an average of eight connections per peer and each query is propagated eight times (or eight “hops”) among peers. In this example, the amount of bandwidth utilized across the network for this one query is over 1.2 gigabytes.

Clearly, reducing the amount of bandwidth required to process queries in a decentralized peer-to-peer network is desirable. Processing queries more efficiently may provide other benefits such as greater scalability, balancing of network loads, lower latency of queries, and greater efficacy of searches.

### SUMMARY

Methods and apparatus are disclosed for representing data available in a peer-to-peer network of processing nodes. In one arrangement, respective Bloom-Filters may be formed at the nodes as a function of data available via the nodes. The Bloom-filters may be communicated between peer-to-peer coupled nodes of the peer-to-peer network that have formed connections using incentive-based criteria to control whether one node connects to another node. A search expression may be formed for locating a data object, and nodes selected as a function of the Bloom-filters and the incentive-based criteria. The search expression may be propagated to the selected nodes, and the result of the search expression output from nodes that satisfy the search expression.

### BRIEF DESCRIPTION OF THE DRAWINGS

FIG. 1 is a diagram of system in which a peer-to-peer network may be employed according to embodiments of the present invention;

FIG. 2 is a network node diagram illustrating the use of Bloom-filters in a peer-to-peer arrangement according to various embodiments of the present invention;

FIG. 3 is a diagram illustrating the use of a counter array for tracking Bloom-filter changes in accordance with embodiments of the present invention;

FIG. 4 is a flowchart showing a procedure for ranking remote Bloom-filters according to embodiments of the present invention;

FIG. 5 is a flowchart of a procedure for propagating Bloom-filter updates according to embodiments of the present invention; and

FIG. 6 is a diagram of a data processing arrangement for connecting with a peer-to-peer network according to various embodiments of the present invention.

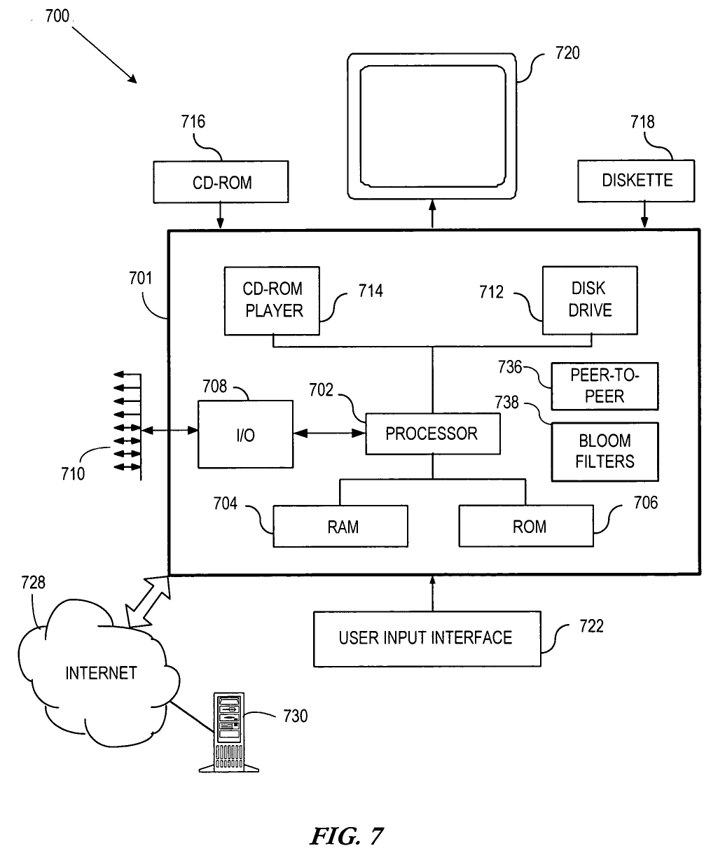

### DETAILED DESCRIPTION

In the following description of various embodiments, reference is made to the accompanying drawings which form a part hereof, and in which is shown by way of illustration various example manners in which the invention may be practiced. It is to be understood that other embodiments may be utilized, as structural and operational changes may be made without departing from the scope of the present invention.

In general, the present disclosure relates to processing of queries in decentralized peer-to-peer data processing arrangements. In one embodiment, the data processing arrangements of a decentralized peer-to-peer network store at least one Bloom-filter associated with each directly connected peer. The Bloom-filters are used for processing queries on the peer-to-peer network. The Bloom-filters indicate a probability that the associated peer contains a target data object that corresponds to the query, or that the target data object is accessible via the peer. For each query, the data processing arrangements may form a ranking based on the Bloom-filter and the query, and send the query to those peers that satisfy a threshold ranking. The data processing arrangements also have a mechanism for updating the Bloom-filters for various events, including removal and insertion of peers and data objects onto the network.

Bloom-filters are data structures that allow representation of the membership of a set or collection. When accessing a collection of stored items, an efficient method is desirable for querying whether a specific item is in the collection. The simplest method is to test the query against each item in the set until a match is found. This simple method may work well for small collections, but may be inefficient when the collection size grows larger. A Bloom-filter can be utilized to speed up this type of query.

A Bloom-filter may be represented as a bit-vector that is m-bits wide. In most cases, the Bloom-filter may be initialized to all zeros. For each item in the collection, the Bloom-filter is populated by performing k-independent hash functions on the item. These hash functions may be performed on the item itself (e.g., a file) or on a representation of the item (e.g., file name or URI). Each hash function returns a result in the range of {1, . . . ,m}. The bits in the bit-vector corresponding to the results of each hash functions are set to one. This procedure is performed for every item in the set. If a bit corresponding to a hash function result has already been set to one in the bit-vector, then the bit remains one.

When querying whether a specific item is in the collection, a Bloom-filter for that item can be formed using the same k-hash functions used to form the collection's Bloom-filter. Performing the query involves checking if each bit that is set to one in the query filter is also set to one in the collection filter. If at least one bit is not set in the collection filter, then the item is not in the collection. If all the corresponding bits are one in the collection filter, this indicates a probability that the item is in the collection, although there may be a probability that the item is not in the collection (i.e., a false positive). However, there are ways known in the art to minimize the probability of false positives taking into account the collection size, the size of the vector m, and number of hash functions k. Even with the occasional false positive, Bloom-filters may provide a significant performance improvement over linear searches in many applications.

One use of peer-to-peer networks is for locating a specific data object on a network. Data objects can be any sort of data accessible from the network. In many applications, the data objects are computer files, although those skilled in the art will appreciated that data objects may be any machine accessible data, such as data streams, metadata, and identifiers (e.g., hostnames, usernames).

A simple method of processing the queries on a peer-to-peer network involves broadcasting the query to all directly connected peers. The peers examine the query and broadcast it to their directly connected peers, and so on. This method may be effective, although not particularly efficient. This lack of efficiency may become important when large numbers of peers are connected to the network. In a file sharing network such as one using the Gnutella protocol, there may be millions of users connected at any one time, with a correspondingly large number of available data objects.

To improve query efficiency, each data processing arrangement that have data objects to share can build a local Bloom-filter (LBF) based on the peer's locally accessible data objects. The peer may also build a set of remote Bloom-filters (RBF) corresponding to each host to which the peer is directly connected. The RBFs indicate the probability that the host associated with the RBF can satisfy a query. The peer can use the RBF to route queries by comparing the query to each RBF, and sending the query only to those that are likely able to fulfill the request. Each peer can also publish its LBF as well as a combination of its RBFs to each new user that connects to the peer. The peers use these Bloom-filters to limit queries only to those peers likely to fulfill the query, therefore making more efficient use of network bandwidth.

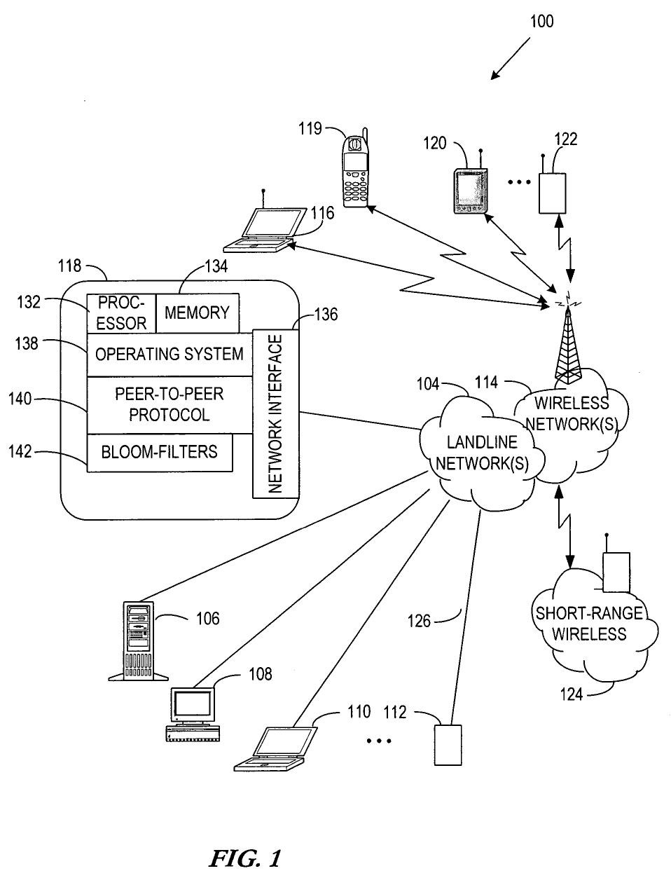

Referring now to FIG. 1, a representative system environment 100 is illustrated in which a peer-to-peer system may be employed according to embodiments of the present invention. In the representative system environment 100, peers may connect in any number of known ways. These ways include landline network(s) 104, which may include a Global Area Network (GAN) such as the Internet, one or more Wide Area Networks (WAN), Local Area Networks (LAN), and the like. Any computing device or other electronic device that supports the appropriate peer-to-peer protocol may utilize Bloom-filter query processing, such as servers 106, desktop computers 108 or workstations, laptop or other portable computers 110, or any other similar computing device capable of communicating via the network 104, as represented by generic device 112.

Peer-to-peer networking may be conducted via one or more wireless networks 114, such as Global System for Mobile Communications (GSM), Universal Mobile Telecommunications System (UMTS), Personal Communications Service (PCS), Time Division Multiple Access (TDMA), Code Division Multiple Access (CDMA), or other mobile network transmission technology. Peer-to-peer capabilities may be included in any mobile electronic device, such as laptop or other portable computers 116, mobile phones 119, Personal Digital Assistants (PDA) 120, or any other similar computing device capable of communicating via the wireless network 114, as represented by generic device 122.

Peer-to-peer arrangements may utilize short-range wireless technologies 124, such as Bluetooth, Wireless Local Area Network (WLAN), infrared (IR), etc. In other arrangements, computing arrangements may join a network via direct wired connections, such as depicted by connection path 126. The concepts presented relating to peer-to-peer data transfer are applicable regardless of the manner in which data is provided or distributed between the target devices.

An example of a target device that utilizes a peer-to-peer data accessing arrangement is illustrated as the generic computer 118. The computer 118 may include a processor 132, some form of memory 134, and a network interface 136. An operating system (OS) 138 may be included to control the computer 118.

The computer 118 may include some form of peer-to-peer networking module 140 implemented in any combination of software and hardware. The peer-to-peer networking module 140 may communicate using the appropriate network and application protocols, and may include the ability to generate and store Bloom-filters 142 for any data objects contained in the computer 118, as well as receiving and storing Bloom-filters 142 from connected peers.

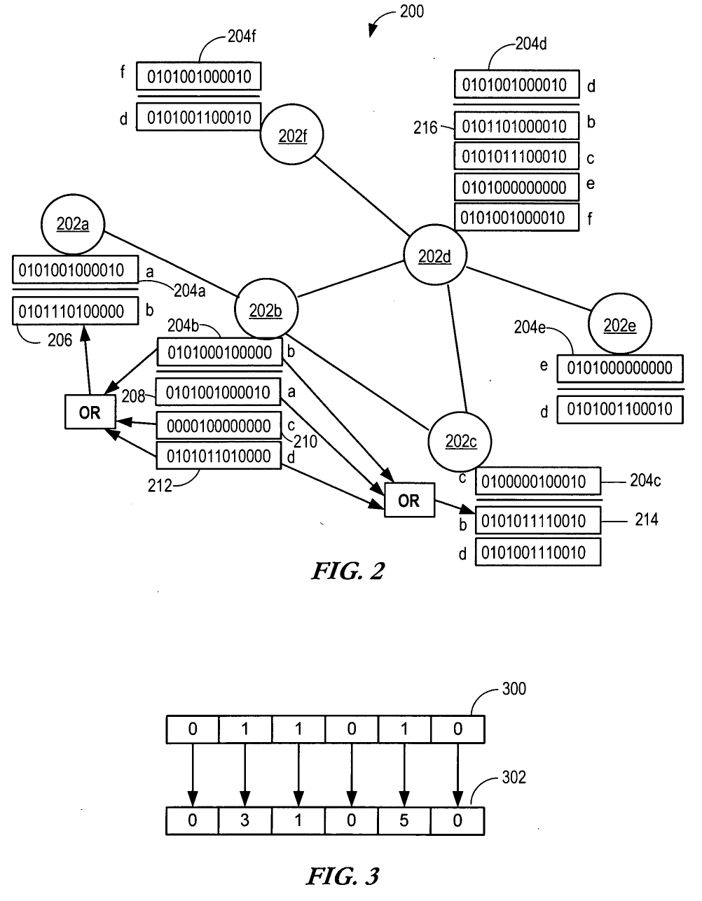

One approach of processing network queries using Bloom-filters is illustrated in FIG. 2 according to various embodiments of the invention. A system 200 of peer-to-peer networked entities is illustrated. These entities are represented as nodes 202a-f. Each node 202a-f may act as a servent, that is the nodes 202a-f can both serve data objects to peers and receive data object from peers.

The system 200 typically utilizes common protocols that can be used by the nodes 202a-f. The common protocols include at least the peer-to-peer protocol, and may include lower level network protocols that are part of the protocol stack. For example, the Gnutella protocol is one example of a peer-to-peer protocol, and is often run on top of the Transmission Control Protocol/Internet Protocol (TCP/IP). The nodes 202a-f may inter-communicate using some version of Gnutella on TCP/IP, even though the applications, operating systems, and architectures may vary between nodes. Gnutella connections formed in this manner are typically TCP/IP sockets, although other network protocols such as Asynchronous Transfer Mode (ATM) may be used if the higher level protocol allows it.

It will be appreciated that the nodes 202a-f may form the peer-to-peer network using multiple network and peer-to-peer protocols. The use of Bloom-filters for query routing may be implemented in the peer-to-peer protocol and be independent of the underlying network protocols. Additionally, the use of Bloom-filters to route queries may be may adapted for independent or simultaneous use with multiple peer-to-peer protocols known in the art.

In this system, each node 202a-f exchanges data traffic with peers using local, incentive based decisions. These incentive-based decisions may be implemented as part of the peer-to-peer protocol. For example, node 202c has connections to nodes 202b and 202d. Node 202c may use incentive-based criteria for determining whether to initially connect to nodes 202b, 202d, as well as which nodes (if any) are favored for routing requests or downloading data. These incentive-based decisions may use any criteria. Typically, incentive-based data traffic criteria are based on network performance measures such as connection bandwidth, latency, reliability, etc. The nodes 202a-f may use other factors besides network performance to make incentive-based data transfer decisions, such controlling access to nodes for reasons such as data integrity, trustworthiness, cost, and security.

Each node 202a-f may route queries or other data transfers to one or more directly connected nodes, also referred to herein as “peer-to-peer connected” nodes. In general, peer-to-peer or directly connected nodes are defined as nodes having a data connection therebetween using the peer-to-peer protocol. For example, if the peer-to-peer protocol uses TCP/IP as the underlying network protocol, a TCP/IP socket connection may exist between directly connected nodes.

If the underlying protocols of the peer-to-peer network are connectionless (e.g., UDP/IP), then the term directly connected can refer to those nodes that actively initiate data exchange data with one another, typically based on local incentives of the nodes. These nodes may form virtual connections for exchanging data and queries rather than relying on connections of the underlying protocol.

It will be appreciated that the term “directly connected” does not necessarily imply a direct physical connection between nodes. There may be other network entities between two directly connected nodes, such as routers, hubs, bridges, etc. However, when data is transferred between two system nodes without the data traveling though another system node, the two system nodes generally can be considered directly connected nodes.

In an unstructured network as illustrated, the nodes may send queries or perform other data transfers to any combination of directly connected nodes. For example, node 202d may send a query to any combination of nodes 202b, 202c, 202e, and 202f. Although node 202d may limit the query to certain nodes based on local, incentive-based decisions, these decisions are typically based on network performance. Incentive-based query routing decisions typically do not take into account the success of the query. To optimize limited network bandwidth, it is preferable that the node 202d send queries only to those nodes having some probability of fulfilling the request.

Bloom-filters can be used to assist in query routing decisions by indicating which nodes are more likely to fulfill the query. In the illustrated system 200, each node 202a-f is shown with a set of Bloom-filters maintained by that node. The Bloom-filters include local Bloom-filters (LBF) and remote Bloom-filters (RBF). In the illustration, the LBF is shown as top Bloom-filter in a stack of filters associated with the node. The RBFs are shown below the LBF and separated from the LBF by a horizontal line.

The nodes 202a-f form respective LBFs 204a-f to reflect the data locally accessible by the nodes 202a-f. Locally accessible data may include directly coupled memory storage such as disk drives and memory. It will also be appreciated that locally accessible data may include any data accessible by a node of the system that is not provided elsewhere using the peer-to-peer protocol of the system. For example, a device may be able to access network shared storage through protocols such as Server Message Block (SMB) or Network File System (NFS). Although this data may not be considered “locally accessible” in a traditional sense, the device may still share data from those network data storage systems in the same manner as if the data were on an attached drive. This data can be considered locally accessible and included in the LBF, since the device may be the only node in the peer-to-peer system that can access that data.

Each LBF 204a-f can be used by the respective owner nodes 202a-f for lookup of query data. The LBFs 204a-f can also be communicated to other nodes to assist in routing of queries. These LBFs 204a-f may be used to build RBFs for other nodes. In general, an RBF is a Bloom-filter communicated from a first host to a second host based on the data available via the first host. The RBF can be built from the first host's LBF, as well as from RBFs that the first host has received from its direct data connections.

One example of forming and communicating RBFs is shown in relation to nodes 202a and 202b. Node 202a has only one connection, that connection being with node 202b. Therefore node 202a maintains an RBF 206 received from node 202b. Node 202b has connections with three nodes 202a, 202c and 202d. Node 202b maintains three RBFs 208, 210, and 212, that are associated with nodes 202a, 202c and 202d respectively.

Node 202a only has one direct connection, so the RBF 208 sent from node 202a to node 202b is the same as LBF 204a. Node 202b has three direct connections, however, so node 202b can form an RBF 206 targeted for node 202a using multiple Bloom-filter information. In general, node 202b can combine its LBF with some set of the RBFs maintained at node 202b. As shown in FIG. 2, node 202b can form RBF 206 using a logical OR of LBF 204b with RBFs 210 and 212. The RBF 208 is not used for forming RBF 206, since RBF 208 was received from node 202a. In general, a node should not echo any Bloom-filter data back to the nodes from which the Bloom-filter data was received.

In a manner similar to the formation of RBF 206 for node 202a, node 202b sends RBF 214 to node 202c. The RBF 214 includes a logical OR of LBF 204b with RBFs 208 and 212. Each RBF in FIG. 2 may be formed using similar techniques, and communicated between directly connected nodes at least when the nodes enter the system 200.

It will be appreciated that when nodes are inserted or removed from the system, updates to other connected nodes may be needed. Similarly, when a node adds or deletes a locally accessible data object, the node's LBF is modified. This may require RBFs to be updated, since the RBF sent by a node may be formed using the LBF. A system using these Bloom-filter mechanisms may require a way to effectively propagate these system changes.

For example, assuming node 202a was the latest node to join the system 200, node 202a can send RBF 208 to node 202b. In turn, node 202b may propagate the newly added information contained in RBF 208 to directly connected nodes 202c and 202d. This information would be updated in RBF 214 at node 202cand in RBF 216 at node 202d.

This propagation of update RBFs may occur immediately when the network changes occur. In such a technique, the updates will spread across the network until all affected nodes have been informed. In other arrangements, the nodes may send updates only at pre-specified intervals. Nodes may individually determine at what intervals updates are passed along to peers. Nodes may store “group updates”, which can be formed as a conglomeration of pending updates to the peers. The group updates may include updates of the local depository reflected by the LBF as well as updates of RBFs received from directly connected peers.

Of course, other techniques may be employed to limit the bandwidth consumed by updates, as well as preventing problems such as infinite loops. Bloom-filter updates may include data such as unique identifiers, source identifiers, and time-to-live (TTL) values, to prevent looping or excessive propagation through the network. The unique identifier may be any value used to uniquely identify an update from a given source, such as a sequential or random number. The source identifier may be some value (e.g., an IP address) that identifies the originator of the update. The unique identifier and source identifier may be used to detect whether this update has been received and processed at the local node. If the update has already been received, then the update can be safely ignored and not further propagated.

A TTL value may be used with updates to prevent over-propagation of updates. A value indicating the maximum TTL may be included with the update along with a current count of hops. The hop count can be incremented each time the update passes between two directly connected nodes. If the hop count exceeds the TTL, the update does not need to be propagated any further, although it may be processed if not redundant.

The process of updating a Bloom filter by adding a new filter may be performed by logically OR'ing the new updates with the filter. However, the removal of Bloom-filters is more involved, because more than one multiple, independent Bloom-filter may set a bit at the same position of the combined Bloom-filter array. Therefore, when subtracting a Bloom-filter, the subtracted array positions cannot automatically set the positions of the subtracted filter to zero.

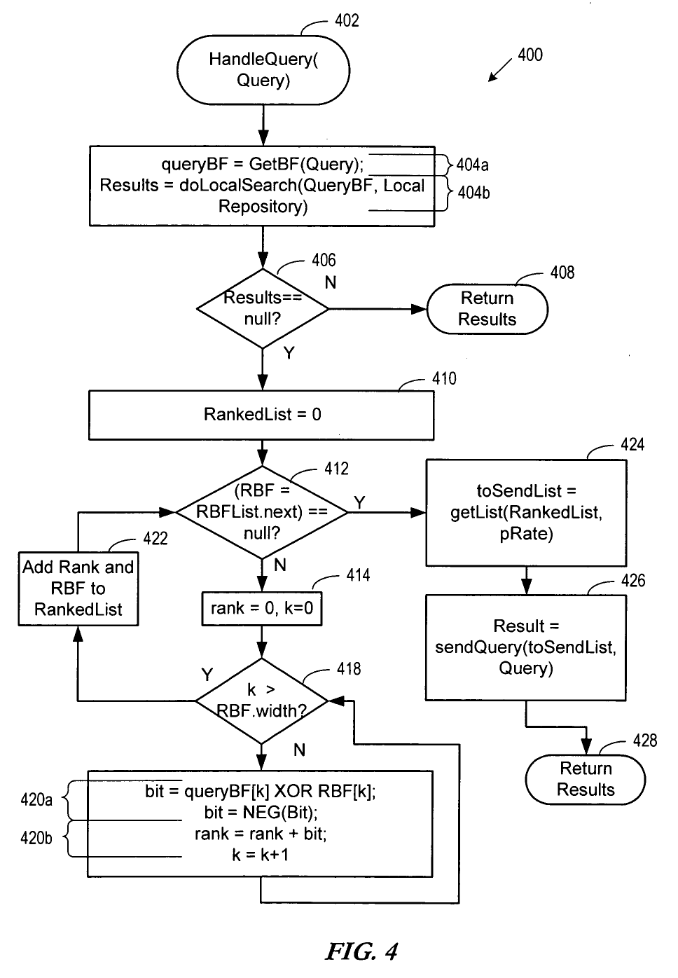

In reference now to FIG. 3, a technique of adding and subtracting updates to a Bloom-filter is illustrated according to embodiments of the present invention. A Bloom-filter array 300 may represent a combination of various Bloom-filters updates. For convenience, the Bloom-filter array 300 is illustrated as six bits wide, although in practice the Bloom-filter array 300 can be any width, and is usually much larger. The Bloom-filter array 300 can be associated with a counter structure 302. The counter structure 302 has a cell (e.g., a counter) corresponding to each bit in the Bloom filter array 300. The counter structure 302 may be formed using any data structure known in the art, such as an array of integers. Each cell in the counter structure 302 maintains a count corresponding to the number of times the location in the Bloom-filter array 300 has been added to or subtracted from by various update operations.

When adding new filters to the combined Bloom-filter array 300, each cell in the counter structure 302 corresponding to a bit in the added filter is incremented by one. If a cell in the counter structure 302 increases from zero to one, then the corresponding bit in the Bloom-filter array 300 can also be changed from zero to one. If the counter cell value increases beyond one, the corresponding bit in the Bloom-filter array 300 remains one. Similarly, when removing a filter from the combined Bloom-filter array 300, each position in the counter structure 302 corresponding to a bit in the removed filter is decremented by one. If, after a subtraction, a cell of the counter structure 302 has been decremented to zero, then the associated position in the Bloom-filter is set to zero.

For example, subtracting the filter [0, 1, 0, 0, 0, 0] from the Bloom-filter 300 of FIG. 3 would not result in any change to the Bloom-filter array 300 because the counter structure 302 would retain a two in the second cell. However, subtracting the filter [0, 0, 1, 0, 0, 0] would result in the third bit of the Bloom-filter array 300 being set to zero, because the third cell of the counter structure 302 decrements from one to zero.

The collections of Bloom-filters maintained by network nodes can be used for routing queries. In a peer-to-peer network, a search is initiated by a network agent (e.g., a user) forming a query. The query may contain any unique identifier that is satisfied by one or more identical data objects on the network, or the query may contain a search term that may be satisfied by multiple, different data objects. For example, a search for a music file by artist “Beethoven” may be satisfied by many different and unique files on the network. However, a search for a particular digital version of “Beethoven's 5^{th} Symphony” that has a certain hash value (e.g., MD5 hash value) may be satisfied by one unique data object on the network, although multiple instances of that object may be available on different nodes of the system.

The node that receives the query may first examine its LBF to see if the query can be satisfied locally. The node can also send the query to one or more of its immediate peers. As used herein in relation to a network node, the term “immediate peer” refers to any peers having a direct and open connection to the node. The node originating the query can use its collection of RBFs to determine which immediate peers to route the request, and each subsequent node that receives the query can use its RBFs in deciding how and where to further propagate the query.

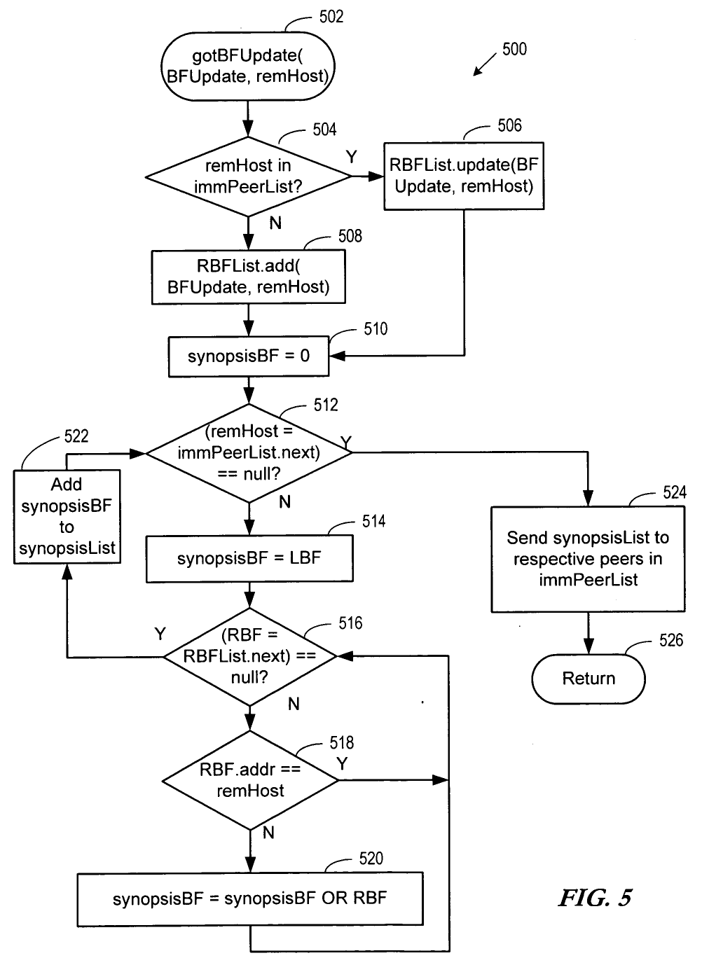

One example procedure 400 of determining which immediate peers should receive a query is illustrated in FIG. 4 according to embodiments of the present invention. The procedure 400 may be entered (402) with a single parameter, that parameter being the query to be processed. A query Bloom-filter called queryBF is formed (404a) using the query, and the local repository is searched (404b). If the local repository can satisfy the query, i.e. the result is not null (406), then the results may be returned (408). Otherwise, a query of other network nodes may proceed. It will be appreciated that in some cases, the network query will still proceed even if the query could be satisfied locally (408). This may be the case, for example, when multiple unique data objects may satisfy the query.

A list of immediate peers may be examined to determine which, if any, immediate peers to which the query should be forwarded. This list of immediate peers can be arranged into a data structure called RankedList, which is initialized (410) to zero (or empty).

For purposes of this example, it is assumed a list of immediate peers and their associated RBFs is stored in an existing collection, RBFList. RBFList may contain data structures that includes the RBF associated with a directly connected host, as well as other host data such as an IP address. The entries of RBFList are ranked by checking the entry's RBF versus query, and placing the entry in RankedList according to this rank. An RBF is extracted from RBFList and checked for null (412), that would indicate the end of the list. If an RBF is available, two local variables rank and k are initialized (414) to zero. While k is less than the width of the RBF (418), the kth bit of the RBF is compared to the kth bit of queryBF, setting a local variable called “bit” to a one if the bits are the same, and a zero if not (420a). The value of bit is added to the rank, and k is incremented by one (420b). This continues until k equals the size of the RBF (418). In this way, the rank is formed as a count of the matching bits of the queryBF and the RBF.

In the procedure just described, the rank for the RBF is increased if the associated bits in RBF and queryBF are the same, regardless if they are both one or zero. This can be considered a count of bits of queryBF that match the bits of RBF. In another arrangement, the rank may be formed as a sum of the bits of the queryBF that match the RBF bits. This could be expressed as rank=rank+(queryBF[k]*RBF[k]) in the expression of 420b. The variable “rank” would be incremented by one if the associated array location of the Bloom-filters include matching ones, and would not be incremented if the array location of either Bloom-filter included a zero.

The value of rank is added to RankedList along with the associated RBF (422). After the last RBFList element is found (412), rankedList contains a list of RBFs and a rank associated with each RBF in the list.

A second list named toSendList is derived (424) from rankedList. This may involve selecting items from rankedList that satisfy a threshold value, pRate, and placing those items in toSendList. The threshold value pRate may be a simple numerical threshold that determines whether or not the query gets routed to a node. For example, pRate could include a threshold value of Rank calculated for each element in RankedList.

In another example, pRate can be defined as the percentage of peers that will be selected (out of the total possible immediate peers) to forward/send the query. This may be expressed as pRate=((no of peers to send or forward the query)/(total number of immediate peers))*100. If the cardinality of RankedList is Nₜₒₜₐₗ, and the cardinality of toSendList is N_{send}, then the number of peers who the query will be sent can be expressed by N_{send}=pRate*Nₜₒₜₐₗ/100. In other words, the first N_{send} elements from the RankedList are selected, which corresponds to the N_{send} highest ranked peers in RankedList.

Other factors may also be included with pRate to determine whether a host receives the query, such as incentive-based routing criteria (e.g., connection bandwidth). The toSendList is then used to transmit (426) the query to the appropriate hosts and the results of this query are then returned (428).

The example querying procedure 400 may result in the query being forward to any number of immediate peers. The query may be sent to no peers at all if the threshold is not satisfied. However, it may be desirable to send the query to at least one connected peer at a minimum, based either on a ranking or some other incentive-based selection criteria. It will be appreciated that if each peer forwarded the request to a single, immediate peer that has the highest ranking, the query would proceed as a directed walk through the peer-to-peer network.

By limiting the number of nodes that receive a peer-to-peer data object query, the network bandwidth may be used more effectively. Other features may be included with the queries to reduce the utilized bandwidth. A TTL and hop count value may be included with the queries to ensure the queries do not propagate past a certain level in the network. Each node that receives a query may increment the hop count and check the TTL before forwarding query.

Each node in the system may maintain a set of Bloom-filters used for processing system queries. In order for the data referenced by the Bloom-filters to be accurate, occasional system updates may be required. This update process will generally update Bloom-filters by reflecting data objects added or removed from the peer-to-peer network. The removal of data objects may occur due to connected nodes changing available data, such as through deletions and additions to local data sources. Data objects may also be added or deleted when nodes are inserted or removed from the network.

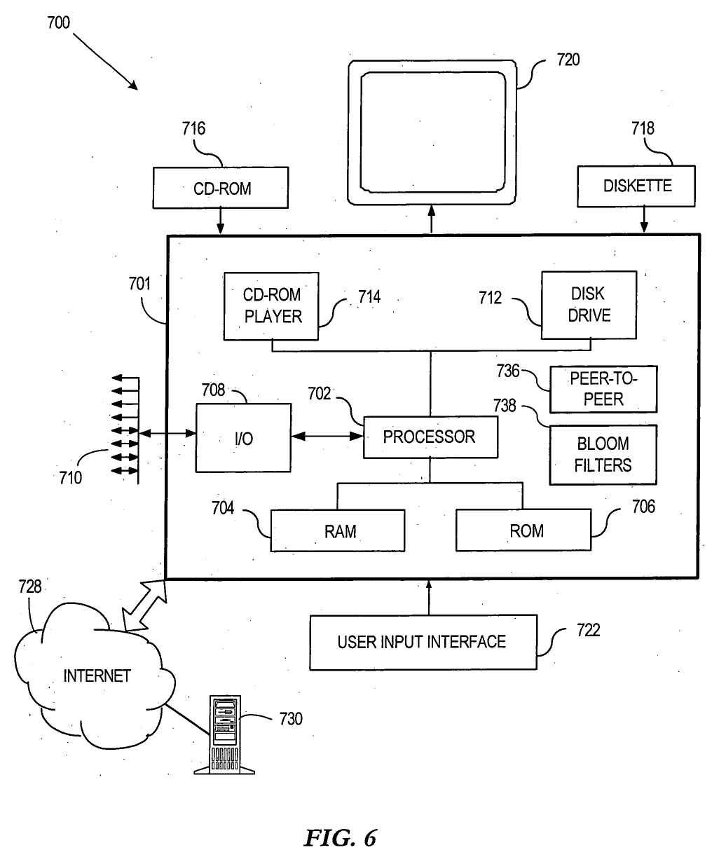

As previously described, when first connecting to a peer-to-peer network, a node may at least publish its the LBF that reflects locally available data objects. Other updates may be triggered by addition or deletion of a data object locally accessible by a node. One example of how a node may handle updates received from a peer node is shown in the flowchart 500 of FIG. 5. The procedure begins (502) with the received Bloom-filter update, BFUpdate, and an identifier of the remote host, remHost. The remhost identifier is typically an IP address, although other identifiers may be used. The remHost identifier may be checked (504) to see if this host is in the immediate peer list. In this example, the list of identifiers for immediate peers is contained in the collection immPeerList. If remhost is in immPeerList (504), the local collection of RBF data is updated (506). This collection of RBF data is represented as RBFList, similar to the example of FIG. 4.

If the address of the updating host is not in the list, then this may be a newly connected peer, and the BFUpdate and remHost may be added (508) to the RBFList collection. Once this maintenance of the RBFList is complete, the receiving node can proceed to send the update to immediate peers. For each peer, a synopsis Bloom-filter is formed that represents the data accessible by other immediately connected peers.

The list of immediate peers is traversed by removing each host identifier from immPeerList and checking (512) for the end of list (e.g., a null). The synopsis for this node is initialized (514) to the LBF. The synopsis may be initialized to other values, such as a zero vector, in cases where no LBF is used to advertise locally available data. Next, the list of RBFs is traversed by removing each RBF from RBFList and checking (516) for null. The RBF removed from RBFlist contains a reference to the address of the peer that will receive the RBF.

The updated RBF sent from this node to an immediate peer should not include any Bloom-filter data of the immediate peer. Therefore, if the address of this RBF equals (518) that of the destination peer, the RBF is skipped from being added to the synopsis. Otherwise, the RBF can be logically OR'd (520) to the synopsis. Once all the RBFs in RBFList have been traversed, the synopsis may be added (522) to the list. After a synopsis has been built for each immediate peer, the list can be sent (524) to the immediate peers, and the procedure can exit (526).

The network clients, servers or other systems for providing peer-to-peer networking using Bloom-filter query routing may be any type of computing device capable of processing and communicating digital information. An example of a representative computing system capable of carrying out operations in accordance with embodiments of the present invention is illustrated in FIG. 7. Hardware, firmware, software or a combination thereof may be used to perform the various querying and data transfer operations described herein. The computing structure 700 of FIG. 7 is an example computing structure that can be used in connection with such a peer-to-peer system.

The example computing structure 700 includes a computing arrangement 701. The computing arrangement 701 may act a servent or other network entity used for processing and delivering data objects in a peer-to-peer network. The computing arrangement 701 includes a central processor (CPU) 702 coupled to random access memory (RAM) 704 and read-only memory (ROM) 706. The ROM 706 may be any type of storage media used to store programs, such as programmable ROM (PROM), erasable PROM (EPROM), etc. The processor 702 may communicate with other internal and external components through input/output (I/O) circuitry 708 and bussing 710, to provide control signals and the like. For example, processing of queries may be performed by the computing arrangement 701 directed by instructions from a peer-to-peer protocol module 736 that references stored Bloom-filters 738.

External data storage devices, such as databases used for accessing data object queries, may be coupled to I/O circuitry 708 to facilitate data transfer functions according to the present invention. Alternatively, such databases may be locally stored in the storage/memory of the server 701, or otherwise accessible via a local network or networks having a more extensive reach such as the Internet 728.

The computing arrangement 701 may also include one or more data storage devices, including hard and floppy disk drives 712, CD-ROM drives 714, and other hardware capable of reading and/or storing information such as DVD, etc. In one example, software for carrying out peer-to-peer queries based on Bloom-filters may be stored and distributed on a CD-ROM 716, diskette 718 or other form of media capable of portably storing information. These storage media may be inserted into, and read by, devices such as the CD-ROM drive 714, the disk drive 712, etc. The software may also be transmitted to computing arrangement 701 via data signals, such as being downloaded electronically via a network, such as the Internet 728. The computing arrangement 701 may be coupled to a display 720, which may be any type of known display or presentation screen, such as LCD displays, plasma display, cathode ray tubes (CRT), etc. A user-input interface 722 may be provided, including one or more user interface mechanisms such as a mouse, keyboard, microphone, touch pad, touch screen, voice-recognition system, etc.

The computing arrangement 701 may be coupled to other computing devices, such as landline and/or wireless terminals via a network, for peer-to-peer networking. The computing arrangement 701 may be part of a larger network configuration as in a global area network (GAN) such as the Internet 728, which allows connections to the various landline and/or mobile devices, such as a peer node 730.

From the description provided herein, those skilled in the art are readily able to combine hardware and/or software created as described with appropriate general purpose or system and/or computer subcomponents embodiments of the invention, and to create a system and/or computer subcomponents for carrying out the method embodiments of the invention. Embodiments of the present invention may be implemented in any combination of hardware and software.

The foregoing description of the example embodiments of the invention has been presented for the purposes of illustration and description. It is not intended to be exhaustive or to limit the invention to the precise form disclosed. Many modifications and variations are possible in light of the above teaching. It is intended that the scope of the invention not be limited with this detailed description, but rather the scope of the invention is defined by the claims appended hereto.

1. A processor-implemented method for searching for a data object in a plurality of nodes forming a peer-to-peer network, the method comprising:
forming Bloom-Filters at the nodes as a function of data available via the nodes;
communicating the Bloom-filters between peer-to-peer coupled nodes of the peer-to-peer network that have formed connections using incentive-based criteria to control whether one node connects to another node;
forming a search expression for locating the data object;
selecting nodes to propagate the search expression as a function of the Bloom-filters and the incentive-based criteria;
propagating the search expression to the selected nodes; and
outputting a result of the search expression from nodes that satisfy the search expression.

2. The method of claim 1, wherein forming respective Bloom filters at the nodes includes combining Remote Bloom-filters (RBFs) received from peer-to-peer coupled nodes of the respective nodes.

3. The method of claim 1, wherein selecting the nodes includes forming a query Bloom-filter based on the search expression and comparing the query Bloom-filter to the respective Bloom-filters.

4. The method of claim 3, wherein comparing the query Bloom-filter to the respective Bloom-filters includes forming a ranking associated with respective Bloom-filters as a sum of bits of the query Bloom-filter that match the bits of the respective Bloom-filter.

5. The method of claim 3, wherein comparing the query Bloom-filter to the Bloom-filters includes forming a ranking associated with respective Bloom-filters as a count of bits of the query Bloom-filter that match the bits of the respective Bloom-filter.

6. The method of claim 1, wherein forming the respective Bloom filters at the nodes includes forming the respective Bloom filters as a function of a local Bloom-filter based on data locally accessible by the respective nodes.

7. The method of claim 1, wherein the peer-to-peer network comprises a Gnutella network.

8. A system comprising:
a plurality of data processors coupled via a peer-to-peer network arrangement, each data processor including;
a network interface arranged to provide one or more respective connections with one or more associated data processor of the peer-to-peer network arrangement, the connections formed using an incentive-based criteria;
a memory for storing one or more respective remote Bloom filters representing data accessible via the associated connections; and
a processing unit arranged to;
form a query Bloom-filter based on a data query;
select a subset of the connections as a function of the query Bloom-filter and the respective remote Bloom-filters associated with the connections; and
send the data query to the subset of the connections.

9. The system of claim 8, wherein at least one data processor of the plurality of data processors further includes a local data storage adapted for storing data objects.

10. The system of claim 9, wherein the memory of the at least one data processor is configured for storing a local Bloom-filter representing data accessible via the local data storage.

11. The system of claim 8, wherein the processing units of the data processors are further arranged to publish a Bloom-filter to a selected connection of the one or more connections, the Bloom-filter representing data accessible via the respective data processors.

12. The system of claim 11, wherein the Bloom filter is formed as a logical OR of the remote Bloom filters of the respective data processors except for the remote Bloom filter associated with the selected connection.

13. The system of claim 11, wherein at least one data processor of the plurality of data processors further includes a local data storage adapted for storing data, and the memory of the at least one data processor is configured for storing a local Bloom-filter representing data accessible via the respective local data storage.

14. The system of claim 13, wherein the Bloom filter is formed as a logical OR of:
the local Bloom-filter; and
the remote Bloom filters of the respective data processor except for the remote Bloom filter associated with the selected connection.

15. The system of claim 8, wherein the peer-to-peer network arrangement includes a Gnutella network arrangement.

16. A computer-readable medium having instructions stored thereon which are executable on a processor for performing steps comprising:
forming one or more respective peer-to-peer connections with one or more network peers of the processor using an incentive-based criteria;
receiving respective remote Bloom-filters representing data accessible via associated peer-to-peer connections;
forming a query Bloom-filter based on a data query;
selecting a subset of the peer-to-peer connections as a function of the query Bloom-filter and the respective remote Bloom filters associated with the peer-to-peer connections; and
sending the data query to the subset of the connections.

17. The computer-readable medium of claim 16, wherein the steps further include forming a local Bloom-filter based on data accessible via a local data storage of the processor.

18. The computer-readable medium of claim 16, wherein the steps further include sending a Bloom-filter to a selected peer-to-peer connection of the one or more peer-to-peer connections indicating data accessible via the processor.

19. The computer-readable medium of claim 18, wherein the Bloom filter is formed as a logical OR of the remote Bloom filters of the processor except for the remote Bloom filter associated with the selected peer-to-peer connection.

20. The computer-readable medium of claim 11, wherein the peer-to-peer connections utilize a Gnutella protocol.

21. A method for updating a Bloom-filter array having a plurality of bits that indicate data accessible via a peer-to-peer network, comprising:
associating respective counters with the bits of the Bloom-filter array;
receiving a Bloom-filter update having a plurality of bits associated with the bits of the Bloom-filter array that indicate a change in the data accessible via the peer-to-peer network;
changing the respective counters based on the associated bits of the Bloom-filter update;
setting the bits of the Bloom-filter array to zero where the respective counters associated with the bits are zero; and
setting the bits of the Bloom-filter array to one where the respective counters associated with the bits are greater than zero.

22. The method of claim 21, wherein the Bloom-filter update indicates data added to the peer-to-peer network, and changing the counters based on the bits of the Bloom-filter update includes incrementing all counters associated with non-zero bits of the Bloom-filter update.

23. The method of claim 21, wherein the Bloom-filter update indicates data removed from the peer-to-peer network, and changing the counters based on the bits of the Bloom-filter update includes decrementing all counters associated with non-zero bits of the Bloom-filter update.

24. A data processing arrangement, comprising means for storing data objects;
means for forming respective peer-to-peer data connections with one or more network peers using an incentive-based criteria;
means for storing remote Bloom-filters associated with respective peer-to-peer data connections, the Bloom-filters indicating data accessible via the respective peer-to-peer data connections;
means for forming a query for locating one or more data objects of the network peers; and
means for sending the query to a subset of the peer-to-peer data connections as a function of the query and the Bloom filters associated with the respective peer-to-peer data connections.

25. The data processing arrangement of claim 24, wherein the peer-to-peer data connections utilize a Gnutella protocol.
